(19) United States
(12) Patent Application Publication
(10) Pub. No.: US 2006/0259657 A1
(43) Pub. Date: Nov. 16, 2006

(54) Direct memory access (DMA) method and apparatus and DMA for video processing

(75) Inventors: Howard G. Sachs, Los Altos, CA (US); Alan Yiping Guo, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telairity Semiconductor, Inc., Santa Clara, CA (US)

(21) Appl. No.: 11/126,709

(22) Filed: May 10, 2005

(51) Int. Cl. G06F 13/28

(52) U.S. Cl. 710/22

(57) ABSTRACT

A direct memory access method and apparatus therefor are disclosed. A block of data to be transferred from memory using DMA includes organizing the block of data as a linked list of segments of the block of data. A processor specifies a starting address of a starting element in the linked list. Subsequent transfers from memory can occur according to DMA transfer techniques without further intervention from the processor.

### CROSS-REFERENCE TO RELATED APPLICATIONS

The present invention is related to the following commonly owned, applications:
METHOD AND APPARATUS FOR CLOCK SYNCHRONIZATION BETWEEN A PROCESSOR AND EXTERNAL DEVICES, filed concurrently herewith (attorney docket no. 021111-001600US); and
VECTOR PROCESSOR WITH SPECIAL PURPOSE REGISTERS AND HIGH

SPEED MEMORY ACCESS, filed concurrently herewith (attorney docket no. 021111-001300US)

all of which are incorporated herein by reference for all purposes.

### BACKGROUND OF THE INVENTION

The present invention relates to memory access and in particular to an improved direct memory access (DMA) technique. Also disclosed is a specific use of the DMA of the present invention as applied to video data processing.

In typical computer-based applications, the data that passes through computer input/output (I/O) devices must often be performed at high speeds, in large blocks, or large blocks at high speeds. Three conventional data transfer mechanisms for computer I/O include polling, interrupts (also known as programmed I/O), and direct memory access (DMA). Polling is a technique in which the central processing unit (CPU, data processor, etc.) is dedicated to acquiring the incoming data. The processor issues an I/O instruction and polls the progress of the I/O in a loop.

Interrupt driven (programmed) I/O involves the processor issuing the I/O instruction without having to perform polling for completion of the I/O operation. An interrupt is asserted when the operation completes, causing the processor to handle branch to an appropriate interrupt handler to process the completed I/O.

With DMA, a dedicated device referred to as a DMA controller reads incoming data from a device and stores that data in a system memory buffer for later retrieval by the processor. Conversely, the DMA controller writes data stored in the system memory buffer to a device. A typical DMA transfer (e.g., a read operation) sequence involves the following:
processor sets up information for a DMA transfer operation, including memory location and size of data (N bytes) to be transferred
processor initiates DMA transfer operation
N bytes of data are transferred from memory absent processor intervention
processor is interrupted when N bytes of data are transferred from memory
processor ‘processes’ the data
processor sets up information for the next DMA transfer operation
and so on . . . .
   As can be seen, DMA off-loads the processor, which means the processor does not have to execute instructions to perform the actual data transfer. The processor is not used for handling the data transfer activity and is available for other processing activity. Also, in systems where the processor primarily operates out of its cache, data transfer is actually occurring in parallel, thus increasing overall system utilization.

Video processing systems have greatly increased the throughput requirements of a processor. Parallel processor architectures are increasingly used to serve the demands of real-time video by processing video streams in parallel fashion. A typical video operation is the streaming of video from memory to an output device, for example a video display unit. Here, large amounts of data must be transferred out of memory to the screen. In addition, this data transfer must be of sufficient bandwidth to ensure no visual artifacts. Meanwhile, since there is limited memory, video is being loaded into memory. This involves switching between loading video data into memory and setting up for the next DMA transfer, placing a heavy burden on the video processing unit(s). The problem is amplified if some kind of processing of the video is desired prior to outputting it to a display.

It is therefore desirable to be able to move data on and off RAM with even less burden on the processors than is possible with conventional DMA techniques. Video data processing systems would benefit by such improvements, and certainly data processing systems in general can realize substantial gains by such improvements.

### SUMMARY OF THE INVENTION

A DMA transfer method according to the present invention includes a data processing block initiating a first DMA transfer operation to obtain first data. Based at least on address information contained in the first data, a second DMA transfer operation is performed absent further action by the data processing block. The second DMA transfer obtains an additional data block having additional address information. Additional DMA transfer operations are performed in this manner absent intervention from the data processing block to obtain still further blocks of data.

Thus, DMA transfers in accordance with the present invention require only one initial setup for the DMA transfer. For example, a processor need on setup a starting address and a optionally a data length of the first block of data to be DMA-transferred. Subsequent blocks of data can then be DMA-transferred without further intervention from the processor.

### BRIEF DESCRIPTION OF THE DRAWINGS

Aspects, advantages and novel features of the present invention will become apparent from the following description of the invention presented in conjunction with the accompanying drawings, wherein:

FIGS. 1 and 2A show illustrative examples of the storage of a data block in memory according to the present invention;

FIG. 2 illustrates the subsequent read out of a data block stored in memory as shown in FIG. 1 according to the present invention;

FIG. 3 shows the structure of an implementation of a linked list data format according to the present invention;

FIG. 4 is a high level flowchart outlining the processing performed by an output control module during DMA transfer processing according to the present invention; and

FIG. 5 shows a high level block diagram of an illustrative DMA interface that embodies the present invention.

### DESCRIPTION OF THE SPECIFIC EMBODIMENTS

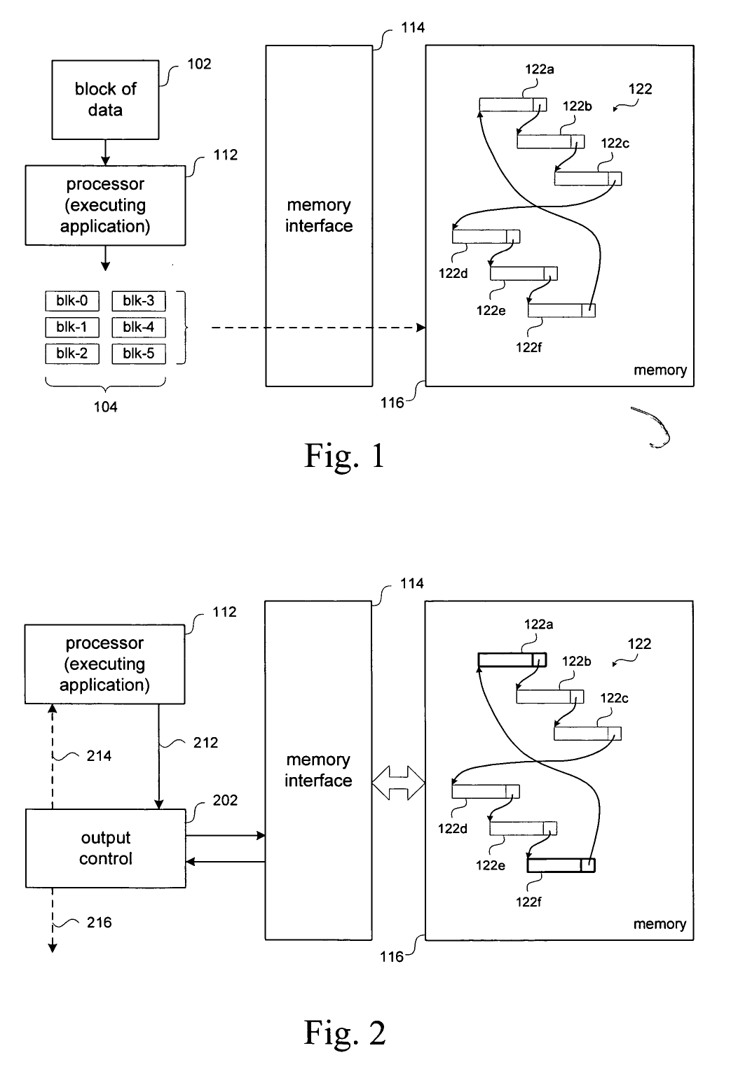

FIG. 1 shows an example of an application executing on a processor 112. The processor accesses a memory 116 via a suitable memory interface 114. The application loads a block of data 102 into the memory 116 in accordance with the present invention. The memory 116 can be a virtual memory system. Specifically, the block of data 102 is segmented in to a set of smaller blocks 104 (sub-blocks, segments, etc.), identified in the figure as blk-0 to blk-5. The smaller blocks 104 are incorporated into a linked list structure 122 comprising, for example, linked list elements 122a-122f. Each linked list element in turn comprises at least one of the sub-blocks 104 and addressing information to another linked list element, referred to as a next address field (see FIG. 3 for a specific implementation). In this way, the data block 102 is stored in memory as the linked list 122. In accordance with the present invention, additional information can be included with each element as will be discussed below.

Storing a single large block of data 102 in the memory 116 typically requires a contiguous area of memory large enough to hold the block of data. An advantage of the present invention arises from the fact that smaller blocks of memory are needed to store the linked list elements since it is easier to allocate smaller blocks of memory than it is to allocate one very large block of contiguous memory. As will be discussed in connection with a more specific embodiment, in order to reduce latency in a video application, it is desirable to be able to store one line of video data and to be able to send out a line of video data at a time.

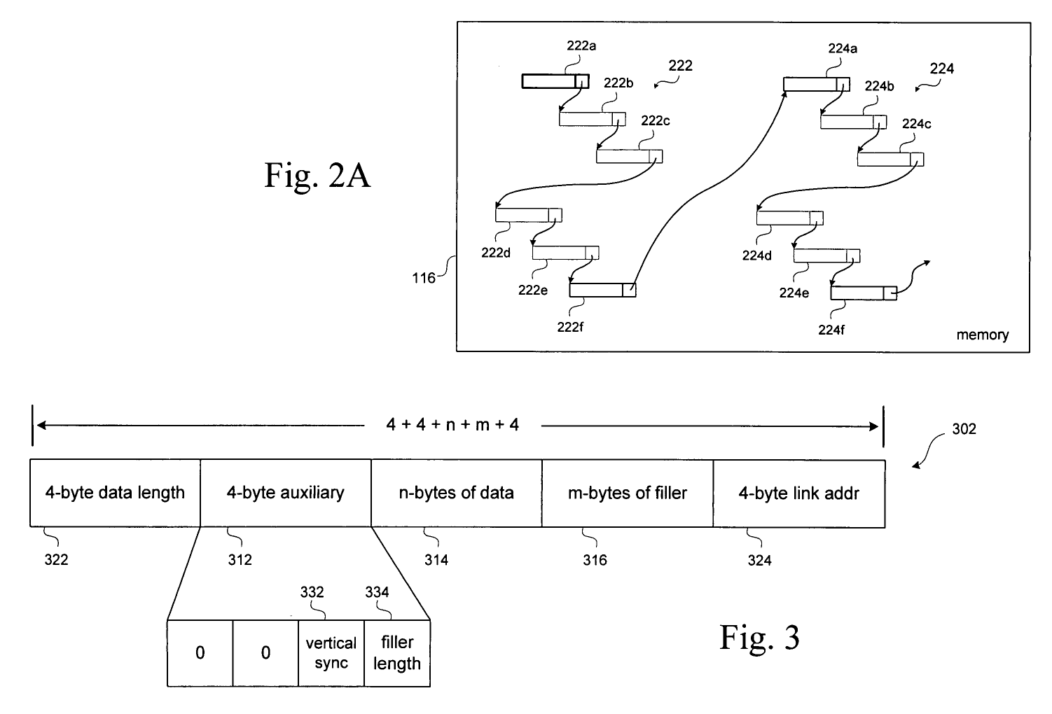

FIG. 2 shows the processing of a DMA transfer operation in accordance with the present invention to read out the block of data 102 as stored in the memory 116. The processor 112, under control of the application program, initiates the DMA transfer by writing information 212 to an output control block 202. In accordance with the present invention, the information 212 that is written by the processor includes the address of a starting element (e.g., linked list element 122a) in the linked list 122. The DMA transfer operation can be initiated in any of a number of ways. For example, the processor 112 can write to a location in the output control block 202 to initiate the DMA operation. A special value can be written to the output control block 202. The processor 112 can assert a signal that is monitored by the output control block 202. Typically, the DMA operation is synchronized to a clock edge.

In response to receiving an indication to begin the DMA transfer, the output control block 202 reads out (fetches) an element from the linked list 122, beginning with the element indicated by the start address, e.g., element 122a. The address in the memory 116 of the next element in the linked list 122 is determined from the next address field in the currently fetched linked list element. The next element is then transferred from memory and processed accordingly. This is repeated for each element in the linked list, so that the linked list elements 122b-122f are subsequently read out. FIG. 2 shows that the output control block 202 can output the data read out from memory 116 to the processor 112 via a data channel 214 or to an external device (not shown) over a data output channel 216.

The linked list 122 allows the entire data block 102 (FIG. 1) to be read out directly from memory 116 via DMA transfer without intervention from the processor 112, after providing some initial setup data 212. More specifically, the processor 112 sets up information to transfer out the starting element of the linked list, or at least a portion of the starting element of the linked list. The set up information includes at least address information giving the location of the first element of the linked list in the memory 116; a data length value can be provided as well. Thus, the DMA setup specifies only one element (e.g., 122a) in the linked list 122. Progress of the DMA transfer according to the present invention allows other blocks of data (i.e., elements in the linked list) to be transferred without requiring set up information from the processor 112 for those other blocks.

The linked list 122 contains information that can be used by the output control block 202 to perform DMA transfer of the entire data block 102. The last element 122f of the linked list 122 points back to the beginning of the list. Consequently, traversal through the linked list 122 can simply be repeated when the last element 122f of the linked list is reached.

In accordance with another aspect of the present invention, the last element in a linked list can point to another linked list. FIG. 2A shows this aspect of the invention. The figure shows two linked lists 222, 224 stored in the memory 116. The last element 222f in the linked list 222 points to a starting element in another linked list 224. The last element 224f in the linked list 224 can point to yet another linked list (not shown), or to any linked list element. For example, it may be desirable in a specific video application that the element 224f point back to the starting element 222a. Logically, the elements 222a-22f and 224a-224f need not be viewed as separate linked lists, but rather just one continuous linked list structure. The logical view that is adopted will depend on the particular data processing system in which the present invention is embodied.

In accordance with still another aspect of the present invention, an application executing on the processor 112 can simultaneously update previously read-out portions of the linked list while subsequent parts of the linked list are being output by the output control block 202. Referring to FIG. 2, for example, a process executing on the processor 112 can write new information into the elements 122a, 122b, 122c, and so on after the output control block 202 reads out these elements. When the output control block reaches the last element 122f, the return link in that element will point back to the starting element 122a. The present invention therefore allows a processor to initiate a continuous DMA transfer operation without subsequent intervention after performing some setup operations; e.g., setting up the data 212 in the output block. Once the DMA transfer begins, the processor 112 can simply write new data to linked list elements that have been read out.

In accordance with yet another aspect of the present invention, new linked list elements written by the processor 112 during DMA transfer processing by the output control block 202 can be written to different partitions of the memory 116. Since each linked list element has a next address field, the next element in the linked list can be located anywhere in memory. This would be useful where some form of “garbage collection” or memory defragmentation processing is performed. Defragmentation is process whereby a memory manager coalesces allocated portions of memory to create large contiguous blocks of free memory for allocation. For example, a linked list can be initially written to a first portion of memory, and a DMA transfer can be initiated. A final element of the linked list in the first memory portion can be made to point to a linked list element stored in a second portion of memory which continues the list in the second portion of memory. When the final element of the linked list in the first portion of memory is read out, DMA transfer can then proceed in the second portion of memory. At this point, the processor 112 can perform some maintenance operations on the first memory portion; e.g., defragmentation, or the like. Note that all the while, the DMA transfer continues without additional instruction from the processor beyond initiation of the DMA operation.

In general, the processor 112 can be any data processing block. Typical examples include microprocessors (e.g., central processing unit CPU) or an application-specific IC (ASIC) that is designed to perform data processing functions. The processor 112 can be digital signal processor (DSP), and so on.

In a particular embodiment of the present invention the processor 112 is a data processing component in a video processing system; e.g., a video encoder. In fact, the processor 112 might comprise a plurality of video processors in a multiprocessor architecture. Accordingly, the data block 102 comprises video data that is processed by the video processing system. The output control block 202 shown in FIG. 2 might be a video output control block in the video processing system that is configured to perform DMA transfers of video data stored in the memory 116 in accordance with the present invention.

The data block 102 can be any unit of video data suitable for the particular video application. For example, each data block can be the video data for an entire video frame; or video field, in the case of interlaced video. Each linked list element can contain the video data for a line in the video frame or field. For example, a video frame might comprise 720 video lines in the case of progressively scanned video (720P). The number of lines varies depending upon the format of the video data such as SD, HD, 10801 etc. It might be convenient to organized the video on a frame by frame basis, where there is a linked list structure for each frame of video. Each linked list structure would comprise a number of linked list elements that constitute a video frame, where each element holds the data for a line of video in the frame. More generally, the video data may be structured such that each linked list hold only a portion of the video frame or field. Video data can be separated out into a luma data stream and a chroma data stream, in the case of component video. A linked list structure can be provided for each data stream.

FIG. 3 shows the structure of a linked list element 302 in accordance with the present invention as embodied in a video processing system. Each element 302 in the linked list includes a four-byte data length field 322. This field is treated as a four-byte datum that indicates the total length of the element. The length of each element 302 in the linked list is not fixed and can vary from one element to the next. A four-byte auxiliary field 312 includes a filler length field 334 and a vertical sync byte 332. The filler length field 334 is a one-byte datum. A data field 314 follows the four-byte auxiliary field 312. The data field 314 can be any length (n) of data. A filler field 316 follows the data field 314 and can be any length (m) of “fill data.” The fill data can be NULLs (0×00), for example. A four-byte next address field 324 points to the next element in the linked list.

Many memory systems impose a constraint on the length of the data transfer. In the particular embodiment of the present invention, the length of the transfer is modulo 128 bytes. Therefore, according to this particular aspect of the invention, each element 302 of the linked list is size-constrained to satisfy the condition that the length is a value modulo-128 (i.e., a value that is an integer multiple of 128, a value divisible by 128 with no remainder). The filler field 316 is used to ensure that this condition is met. The number of bytes of fill data (m) in the filler field 316 is selected to satisfy the condition that the sum (12+n+m) is an integer multiple of 256, where “12” is the size of the three four-byte fields. Given that the data length (n) can be zero, the filler field has a maximum value of “252”, and a minimum value of “0” when the sum (12+n) equals a value modulo-128.

In this particular embodiment of the present invention, the vertical sync byte 332 is encoded with control information. The vertical sync byte 332 is used to indicate the end of a frame of video (hence “vertical sync”). In a particular implementation, a value of 0×01 is used to indicate the end of a video frame. The vertical sync byte 332 can also encode additional information. For example, a value (e.g., 0×03) can be inserted to cause the output control block 202 to immediately cease DMA transfer operations. This is useful for diagnostic purposes.

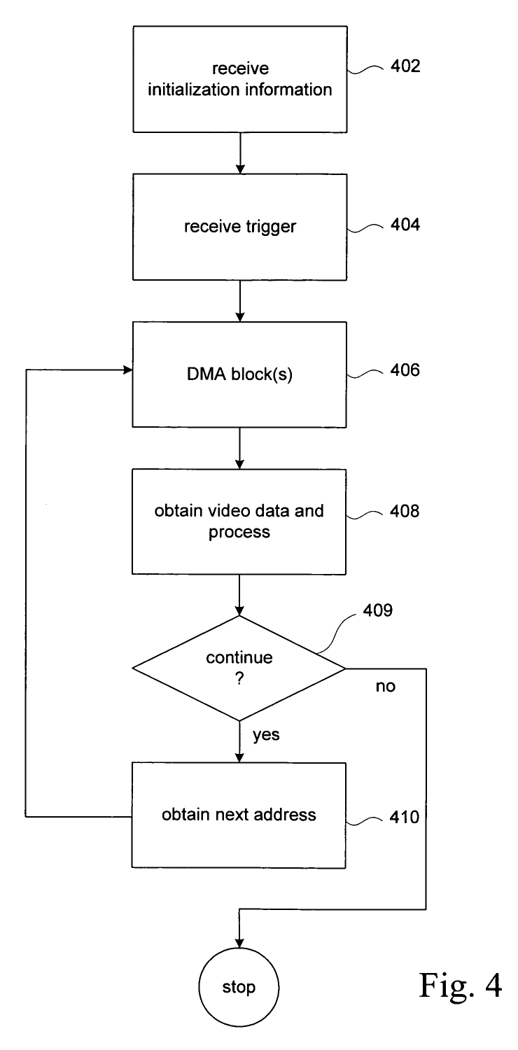

FIG. 4 shows a flow chart 400 of the sequence of actions that the output control block 202 performs during a DMA transfer of video data stored in memory according to the present invention. The output control block 202 is initialized (step 402) with information typically provided by an application executing on the processor 112. This information includes at least an address or the like of a starting element in the linked list. The size of the starting element can also be provided.

DMA transfer processing is performed by the output control block 202 when it is triggered (step 404). The DMA transfer operation can be initiated by the processor 112 in any of a number of well known techniques, including asserting an interrupt, asserting a predefined signal line, writing to an area in the output control block 202, and so on. The output control block contains the address of the starting element in the linked list.

In a step 406, a DMA transfer operation is performed to read out the addressed linked list element. In a video application, the data for a line of video is typically on the order of 1K (1024) bytes. Therefore, in the case that each element in the linked list represents a video line in the video frame or video field, the amount of data that is transferred by the DMA operation is about 1M (2²⁰) bytes. Depending on the memory architecture and the data bus width, reading out an element may require two or more DMA transfer operations. Thus, a first DMA transfer reads out a first portion of the linked list element. Then, a computation can be made based on the data length field 322 to determine if a further DMA transfer operation(s) is needed.

In a step 408, the video data portion of the linked list element is obtained and processed in some manner. This typically involves outputting the video data to a video output channel of the output control block 202, such as the data output channel 216. In accordance with conventional DMA processing, an interrupt or some similar signaling mechanism would be used to interrupt the processor 112 at this time so that the next DMA transfer can be set up by the processor.

However, in accordance with the present invention, a determination is made in a step 409 whether or not to continue traversing the linked list for the next element. Referring to FIG. 3, the particular implementation disclosed herein incorporates an auxiliary filed 312 which contains a vertical sync byte 332. Recall, that this byte indicates whether to continue traversing the linked list (value set to 0×01), or to cease list traversal (value other than 0×01). If list traversal is to continue, then processing proceeds to a step 410, otherwise the processing is complete.

In step 410, the next address field in the currently fetched linked list element is accessed to obtain the address in the memory 116 of the next element in the list. Processing then proceeds to step 406 to obtain the next element. It is noted here that, in accordance with the present invention, DMA processing continues without additional setup by the processor 112. Thus, DMA transfer is continuously performed by repeating steps 406 through 410, absent intervention by the processor 112.

If the last element in the linked list points back to the starting element (i.e., forms a circular linked list), then the linked list will be repeatedly traversed. An application executing on the processor 112 can update each element in the list with new video data after it is read out, thereby effectively outputting another frame or field of video.

The linked list need not be circularly linked. Instead, a process can continuously add elements to the end of the linked list, while another process performs some form of garbage collection processing on elements which have been read out. In these scenarios, it is noted that the processor 112 need not manage any aspect of the DMA transfer operations after the initial steps of establishing the setup data (step 402) to read out the starting element in the linked list and initiating DMA transfer processing (step 404).

The discussion will now turn to a description of a specific embodiment of the present invention in a video processing application. A commonly used video format represents video as a luma data and as chroma data. In this embodiment, a video frame comprises a luma data stream that is stored in the linked list arrangement discussed above. Similarly, a chroma data stream is stored in a separate linked list arrangement. Each element in the respective linked lists constitutes the data for a line of video in the frame. The chroma data actually comprises chroma-R data and chroma-B data. However, a 4:2:2 sampling technique is used to reduce video data storage requirements by undersampling the chroma information. Consequently, the chroma-R and chroma-B data can be combined and stored in the same amount of space as used to store the luma data.

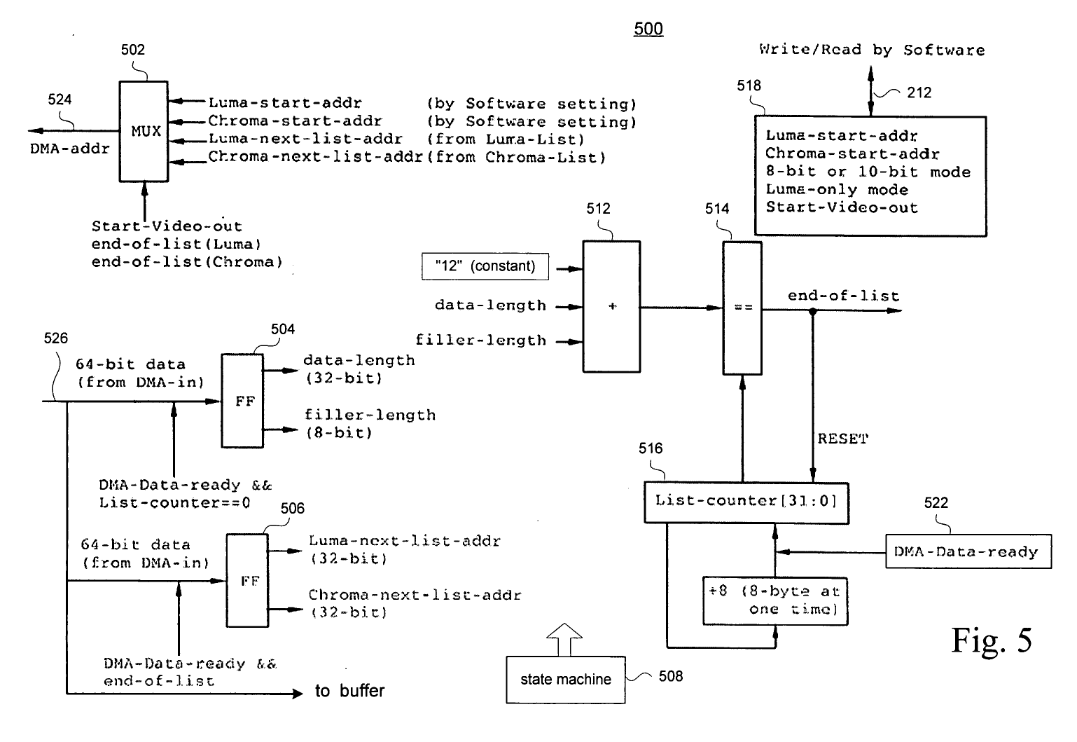

FIG. 5 shows an example of a DMA interface 500 used in the output control block 202 shown in FIG. 2 to perform DMA transfer operations of the luma linked list and the chroma linked list in accordance with a particular embodiment of the present invention. Additional detail for the memory controller 114 will also be provided as needed to explain the design and operation of the DMA interface 500. It will be appreciated that the elements of the DMA interface can be incorporated in the memory controller 114, or may exist as a separate block. In other words, different configurations are possible depending on the implementation.

A signal 522 (DMA-data-ready) from the memory (e.g., DMA) controller 114 feeds into the DMA interface block 500 to indicate that the DMA controller 114 has data to be read out. A DMA address bus 524 feeds into the memory controller 114. A 64-bit data bus 526 from the memory controller 114 feeds into latches 504, 506, and to a buffer (not shown) for storing data read out from the memory 116.

A data store 518 (e.g., register bank) stores starting addresses and other information to initiate a DMA transfer of starting elements from the linked in lists in the memory 116. The information contained in the data store 518 is programmatically accessed. For example, software executing on a processor 112 can write to the data 212 to the data store 518 or read from the data store 518. The information 212 includes a luma start address which identifies a beginning element (622a, FIG. 6) of the linked list for the luma data stream (622) in the memory 116. Similarly, a chroma start address identifies a beginning element (624a) of the linked list for the chroma data stream (624).

The data store 518 also includes information relating to the data size, whether the data is 8-bit data or 10-bit data; the video data can be stored in 8-bit format or 10-bit format. A luma-only datum indicates whether the data to be accessed from the memory 116 contains only a luma data stream. As will be explained below, a video-start datum (Start-video-out) triggers processing to output the stored video data. Thus, the software will set up the address information, and when video output is desired, the video-start datum is written.

The DMA address bus (address lines) 524 is driven by a mux 502. The mux 502 is coupled to receive the luma start address and the chroma start address information contained in the data store 518. The mux 502 also receives a luma-next address and a chroma-next address from a data latch 506 (typically provided by flip-flops). A selector input 502a on the mux 502 selects which of the data into the mux will be driven on the DMA address bus 524.

The 64-bit data bus 526 feeds into the data latch 504. In operation, the data bus 526 initially carries a data length value (322, FIG. 3) in 32 bits of the 64-bit bus and a filler length value (334) in 8 bits of the bus. The data latch 504 outputs the 32 bits which constitute the data length value and the 8 bits which constitute the filler length value contained in the data bus 526. The data length value and the filler length value feed into an adder (summing) circuit 512 as inputs to the adder. The data length value and the filler length value come from the general data structure of each linked list element, shown in FIG. 3.

The 64-bit data bus 526 also feeds into the data latch 506. In operation, the data bus 526 carries a 32-bit address (luma-next) for the next linked list element (e.g., 622b) in the linked list 622 for the luma data stream, and a 32-bit address (chroma-next) for the next linked list element (e.g., 624b) in the linked list 624 for the chroma data stream. Referring again to FIG. 3, the 32-bit luma-next address comes from the four-byte link address field 324 of a linked list element in the luma data stream linked list. Similarly, the 32-bit chroma-next address comes from the four-byte link address field of a linked list element in the chroma data stream linked list. These 32-bit address lines feed into the mux 502.

The adder circuit 512 receives the data length value and filler length value from the data latch 504. A constant value of “12” is also provided to the adder circuit 512. Referring to FIG. 3, it can be seen that the adder circuit 512 computes the length of a given linked list element. The constant value “12” comes from the three four-byte fields that are found in every linked list element: the data length field 322, the auxiliary field 312, and the link address field 324.

The computed sum produced by the adder circuit 512 feeds into a comparator 514. The comparator 514 compares the computed sum with a value from a 32-bit counter 516. The counter 516 counts the number of bytes read from the memory controller 114. In the specifically disclosed embodiment of the present invention, the memory controller 114 outputs eight bytes at a time to the DMA interface block 500. Consequently, the counter 516 is incremented by a constant value of “8”.

The output of the comparator produces a signal when the computed sum and the counter value match. The signal serves to reset the counter. The output of the comparator also serves as a signal that indicates the end of the linked list element has been reached.

A state machine 508 provides control signals and sequencing control to perform the series of operations comprising the DMA transfer operations of the present invention. The state machine is in an idle state until a start-video-out datum is written. In response to receiving the start-video-out datum, the state machine operates the mux 502 to latch the luma-start-address onto the DMA address bus 524.

A block of eight bytes of data is read from the memory, and when that block of data is ready, the DMA-data-ready is asserted; this block is the first eight bytes of the starting element in the linked list for the luma data. The state machine 508 responds by latching in data from the DMA channel 526 into the data latch 504. The data length field 322 and the filler length field 334 are produced and fed into the summer 512, where the sum is computed and compared against the list-counter 516. Data which comprise the data field portion 314 from the channel 526 is then stored to a buffer (not shown). The list-counter 516 is incremented by “8”.

Subsequent 8-byte blocks of the linked list element are read in and stored to the buffer. With each 8-byte block, the list-counter 516 is incremented by “8”. When the last eight bytes of the linked list element are read in, the comparator 514 will assert end-of-list. This will trigger latch 506 to latch in the luma-next address. At this point, one line of luma data has been read out of memory.

The end-of-list signal will cause the state machine 508 to output (via mux 502) the chroma-start address to the DMA address bus 524, to begin reading out the starting element in the linked list for the chroma data. The starting element of the linked list for the chroma data is read out in the same manner as discussed for the starting element of the luma data.

When read out of the linked list element for the chroma data has completed, the chroma-next-address will have been latched into the latch 506. At this point, a line of luma data and a line of chroma will have been read out and buffered. The data can then be processed, for example, simply outputting it on a video out channel.

In the meanwhile, the state machine 508 drives the luma-next-address latched in the mux 502 onto the DMA-address bus 524, to begin DMA transfer of the next element in the luma linked list. When the next element in the luma linked list is read into the buffer (not shown), the state machine 508 drives the chroma-next-address latched in the mux 502 onto the DMA-address bus 524 to read in the next element in the chroma linked list.

Thus, in accordance with the present invention, a single DMA set up operation to read in a first block of data is sufficient to initiate a continuous series of DMA operations to read in additional blocks of data. Significantly, the additional (subsequent) blocks of data are not identified in the initial DMA set up operation. Instead, the additional blocks of data are identified in a previously obtained block of data.

1. A DMA transfer method comprising:
performing a first DMA transfer operation to obtain first data in response to a initiate-DMA-transfer indication that is asserted by a data processing block;
obtaining address information from the first data;
based at least on the first address information performing a second DMA transfer operation to obtain additional data, the second DMA transfer operation being performed absent intervention from the data processing block; and
performing additional DMA transfer operations to obtain further data based at least on addressing information contained in the additional data, the additional DMA transfer operations being performed absent intervention from the data processing block.

2. The method of claim 1 further comprising communicating a starting address from the data processing block prior to performing the first DMA transfer operation, wherein performing the first DMA transfer operation is based on the starting address, wherein the second DMA transfer operation and the additional DMA transfer operations do not require starting address information from the data processing block.

3. The method of claim 1 further comprising communicating a starting address and a data length from the data processing block prior to performing the first DMA transfer operation, wherein performing the first DMA transfer operation is based on the starting address and the data length.

4. The method of claim 1 wherein the data processing block includes a data processor, or a DSP, or an ASIC.

5. The method of claim 1 wherein the data obtained by each DMA transfer operation includes data that indicates whether or not to perform a subsequent DMA transfer operation.

6. The method of claim 1 wherein the data obtained by a DMA transfer operation includes data that indicates the size of the data that is obtained by the DMA transfer operation.

7. The method of claim wherein one of the DMA transfer operations includes obtaining a first portion of data, the first portion of data including size information relating to the amount of data to be retrieved by said one of the DMA transfer operations, wherein one or more further DMA transfer operations is performed depending on the size information.

8. The method of claim 1 wherein the data is organized in a memory as at least one linked list structure.

9. The method of claim 1 as performed in a video processing system.

10. The method of claim 9 further comprising outputting data obtained by the DMA transfer operations to a video output channel in the video processing system.

11. A method of operating an output control logic block to perform DMA transfer operations to read out data stored in a memory, the method comprising:
receiving a first address from a data processing block;
receiving an indication to begin DMA transfer operations;
performing a first DMA transfer operation to read out a first data block from the memory; and
performing subsequent DMA transfer operations to read out additional data blocks from the memory, each subsequent DMA transfer operation using addressing information obtained from a data block obtained from a previous DMA transfer operation,
wherein the subsequent DMA transfer operations are performed absent any intervention by the data processing block.

12. The method of claim 11 further comprising receiving a data length from the data processing block along with the first address.

13. The method of claim 11 wherein the data processing block includes a CPU, or a DSP, or an ASIC.

14. The method of claim 11 wherein the data obtained by each DMA transfer operation includes data that indicates whether or not to perform a subsequent DMA transfer operation.

15. The method of claim 11 wherein the data obtained by a DMA transfer operation includes data that indicates the size of the data that is obtained by the DMA transfer operation.

16. The method of claim 11 wherein one of the DMA transfer operations includes obtaining a first portion of data, the first portion of data including size information relating to the amount of data to be retrieved by said one of the DMA transfer operations, wherein one or more further DMA transfer operations is performed depending on the size information.

17. The method of claim 11 wherein the data is organized in the memory as at least one linked list structure.

18. The method of claim 11 as performed in a video processing system.

19. The method of claim 18 further comprising outputting data obtained by the DMA transfer operations to a video output channel in the video processing system.

20. A direct memory access (DMA) transfer method for accessing a block of data comprising:
receiving from a data processor first information which identifies a first group of data stored a memory;
accessing the first group of data from a location in the memory based at least on the first information;
determining second address information based at least on address information contained in the first group of data, the second address information identifying a second group of data in the memory;
accessing the second group of data from a location in the memory identified by the second address information; and
repeating the accessing and determining steps with respect to additional groups of data stored in the memory, wherein the accessing and determining steps are performed absent interaction with the data processor.

21. The method of claim 20 wherein the recited steps are performed for a first block of data and for a second block of data.

22. The method of claim 21 wherein the first block of data and the second block of data are video data.

23. The method of claim 21 wherein the first block of data and the second block of data together constitute either a frame of video data or a field of video data, wherein the first block of data constitutes a luma component in the frame of video data or the field of video data, wherein the second block of data constitutes a chroma component in the frame of video data or the field of video data.

24. The method of claim 20 wherein the block of data is organized as a link list of plural elements, data each element constituting the block of data.

25. The method of claim 20 wherein the first information includes a starting address.

26. The method of claim 20 wherein the first information includes a starting address and a data length.

27. A DMA transfer method for accessing video information stored in a memory comprising:
(a) reading a first data group from the memory in response to a DMA-initiating action performed by a data processing unit, the first data group comprising a video data portion and an address portion;
(b) outputting the video data portion on a video output channel;
(c) reading a second data group from the memory from a location in the memory determined based at least on the address data component of the first data group, the second data group comprising a video data portion and an address portion;
(d) outputting the video data portion of the second data group on a video output channel;
(e) repeating steps (c) and (d) with respect to subsequent data groups, wherein the location in the memory for each subsequent data group is determined based at least on the address portion of a previous data group; and
performing steps (c) to (e) without additional DMA-initiating actions by the data processing unit,
wherein a plurality of video portions obtained from the data groups together constitute a frame of video or a field of video.

28. The method of claim 27 wherein the location in memory of the first data group is provided by the data processing unit.

29. The method of claim 27 wherein the data processing unit is a CPU, or a DSP, or an ASIC.
